(19) United States
(12) Patent Application Publication
(10) Pub. No.: US 2014/0004357 A1
(43) Pub. Date: Jan. 2, 2014

(54) POLYSILANESILOXANE COPOLYMERS AND METHOD OF CONVERTING TO SILICON DIOXIDE

(71) Applicant: Xiaobing Zhou, Midland, MI (US)

(72) Inventor: Xiaobing Zhou, Midland, MI (US)

(73) Assignee: DOW CORNING CORPORATION, Midland, MI (US)

(21) Appl. No.: 14/003,501

(22) PCT Filed: Mar. 9, 2012
(86) PCT No.: PCT/US12/28390

§ 371 Date: Sep. 6, 2013

Related U.S. Application Data
(60) Provisional application No. 61/451,797, filed on Mar. 11, 2011.

(51) Int. Cl. C09D 1/00

(52) U.S. Cl. CPC C09D 1/00
USPC 428/446; 423/325; 427/58; 556/430

(57) ABSTRACT

Inorganic polysilanesiloxane (PSSX) copolymers and method of making and applying the same to the surface of a substrate is provided. These PSSX copolymers are beneficial in forming a dense silicon dioxide layer on a substrate under mild oxidative conditions. The PSSX copolymers comprise SiₓO_{y}(OH)_{z} units, wherein y and z are defined by the relationship (2y+z)≦(2x+2) and x is either 4 or 5. More specifically, the PSSX copolymers do not contain Si—C covalent bonds.

### FIELD

This disclosure relates generally to inorganic polysilane-polysiloxane resins and their use in electronic devices. More specifically, this disclosure relates to the preparation of polysilanesiloxane (PSSX) copolymers and a method of using these copolymers to form a spin-on film that can be converted into a dense silicon dioxide layer under mild conditions.

### BACKGROUND

Dense silicon dioxide (SiO₂) layers are commonly used in electronic devices as a dielectric or barrier material. These dense layers can be formed using either a chemical vapor deposition (CVD) process or a spin-on deposition (SOD) process. In a CVD process, volatile precursors are reacted in the gas phase such that silicon dioxide is deposited directly onto the surface of the electronic device. Alternatively, the SOD process involves the application of resinous precursors to the surface of the electronic device. These resinous precursors form a film on the surface that is subsequently oxidized to form silicon dioxide. The use of a SOD process offers several advantages over a CVD process, including lower cost and the ability to coat the interstices formed within complex patterns.

Organic polysilanesiloxanes (PSSX) represent the class of copolymers that comprise a hybrid of polysilane and polysiloxane units. The PSSX copolymers may be either linear or resinous in nature. Linear PSSX copolymers are conventionally synthesized through the hydrolytic polycondensation of dichlorooligosilanes, such as Cl(SiMe₂)₆Cl as described in U.S. Pat. No. 4,618,666; the polycondensation that occurs between dichlorooligosilanes and oligosilanediols, such as between Cl(SiMe₂)₆Cl and HO(SiMe₂)₆OH as described in U.S. Pat. No. 5,312,946; or the ring opening polymerization (ROP) of cyclic silaethers, such as (SiMe₂)₄O as described in Japanese Kokai No. H04-065427. Resinous PSSX copolymers are conventionally synthesized through the hydrolytic condensation of chloromethyldisilanes that are formed as a direct process residue (DPR) or by-product in the manufacturing of dichlorodimethylsilane. A more thorough description of the compositions, syntheses, properties, and applications associated with polysilanesiloxane (PSSX) copolymers can be found in a manuscript published by Plumb and Atherton in Copolymers Containing Polysiloxane Blocks, Wiley, New York, (1973), pages 305-53 and in an article authored by Chojnowski, et al. and published in Progress in Polymer Science, 28(5), (2003), pages 691-728.

Organic PSSX copolymers include a substantial number of organo-functional moieties. In other words, organic PSSX copolymers contain a substantial amount of Si—C bonds. These organic moieties need to be removed in order to form a silicon dioxide (SiO₂) layer. Unfortunately, the removal of these organic groups causes undesired high weight loss, high shrinkage, and the formation of porosity in the formed silicon dioxide layer. Thus organic PSSX copolymers are not suitable or desirable precursors for making a dense silicon dioxide layer in an electronic device.

### SUMMARY

In overcoming the enumerated drawbacks and other limitations of the related art, the present disclosure provides inorganic polysilanesiloxane (PSSX) copolymers for use in forming a silicon dioxide layer on a substrate. The PSSX copolymers comprise SiₓO_{y}(OH)_{z} units, wherein y and z are defined by the relationship (2y+z) (2x+2) wherein y and z are numbers greater than or equal to zero and x is either 4 or 5. More specifically, the PSSX copolymers do not contain Si—C covalent bonds.

According to one aspect of the present disclosure, a method of preparing polysilanesiloxane (PSSX) copolymers is provided in which a predetermined number of monomers are mixed into a protic solvent, such as an alcohol, and hydrolyzed under controllable conditions to form the PSSX polymers. Preferably, the hydrolysis is facilitated by the use of an excess of acidified water in the protic solvent. The monomers are selected as one from the group of peralkoxyoligosilanes, alkoxychlorooligosilanes, and mixtures thereof. Several examples of these monomers include, but are not limited to, Si[Si(OMe)₃]₄, Si[Si(OMe)₃]₃[Si(OMe)₂Cl], HSi[Si(OMe)₃]₃, and mixtures thereof; wherein Me refers to a methyl group.

The alkoxychlorooligomers that are preferably used in the present disclosure have the general formula: H_{w}Siₓ(OR)_{y}Cl_{z}, where R is an alkyl group, such as an ethyl or methyl group; w is either 0 or 1; x is either 4 or 5; and y and z are numbers greater than or equal to zero and (y+z) is equal to (2x+2) when w=0 and x=5, or (y+z)=9 when w=1 and x=4.

According to another aspect of the present disclosure, a method of forming a silicon dioxide layer on a substrate is provided that utilizes the PSSX copolymers as described above. In this method, the PSSX copolymers are appied to a substrate, such as an electronic device, to form a PSSX film. More specifically, the PSSX copolymers are applied to the substrate by spin coating, flow coating, or dip coating. The PSSX copolymers may be applied to the substrate while still in the protic or hydrolysis solvent used for the preparation of the copolymers. Optionally, the protic solvent may be replaced with another film forming solvent, such as propylene glycol monomethyl ether acetate (PGMEA), prior to the PSSX copolymers being applied to the substrate.

The PSSX film is mildly oxidized to form a silicon dioxide layer on the substrate. The oxidative process generally comprises the steps of exposing the PSSX film to one selected from the group of steam or oxygen gas; and heating the film to less than about 600° C. for a predetermined amount of time. Optionally, the method may also include further annealing of the silicon dioxide layer under an inert atmosphere, such as nitrogen gas or the like in order to increase the density of the layer. The silicon dioxide layer may be used as a dielectric or barrier material in an electronic device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIGS. 1A-1H are schematic representations of the formulae associated with several different peralkoxyoligosilane or alkoxychlorooligosilane monomers that may be used to prepare the PSSX copolymers according to the teachings of the present disclosure;

FIG. 2 is a schematic representation of methods used to prepare the PSSX copolymers, to form a PSSX film on a substrate, and to convert the film to a silicon dioxide layer according to one aspect of the present disclosure;

FIG. 3 is a graphical representation of the absorption spectrum measured by Fourier transform infrared (FTIR) spectroscopy for a silicon dioxide layer made by the oxidation of a PSSX film according to one aspect of the present disclosure; and

FIG. 4 is a graphical representation of the elution profile obtained by gel permeation chromatography (GPC) for PSSX copolymers prepared according to one aspect of the present disclosure.

### DETAILED DESCRIPTION

The following description is merely exemplary in nature and is in no way intended to limit the present disclosure or its application or uses. It should be understood that throughout the description and drawings, corresponding reference numerals indicate like or corresponding parts and features.

The present disclosure generally provides inorganic polysilanesiloxane (PSSX) copolymers or resins that contain no Si—C bonds, as well as a method of making the same. The present disclosure further provides a method of applying the PSSX copolymers onto a substrate to form a PSSX film; as well as exposing the PSSX film to a mild oxidative cure capable of converting the film to a dense silicon dioxide layer.

The density of the silicon dioxide layer formed from the oxidative conversion of a film comprising the inorganic PSSX copolymers of the present disclosure benefits from there being no Si—C present in the PSSX copolymers. The density of the silicon dioxide layer formed from inorganic PSSX copolymers also benefits in that the conversion of one Si—Si bond to one Si—O—Si bond leads to a 28% mass increase and about an 11% local volume increase. In addition, Si—Si bonds are reactive to oxidation and can be easily converted to Si—O—Si bonds under mild conditions, e.g., at relatively low temperatures. Thus the use of these inorganic PSSX copolymers to form dense silicon dioxide films can provide the benefit of lowering the costs associated with manufacturing an electronic device.

The inorganic PSSX copolymers are prepared according to the teachings of the present disclosure through the controlled hydrolysis of peralkoxyoligosilane monomers, alkoxychlorooligosilane monomers, or a mixture thereof. According to one aspect of the present disclosure, the peralkoxyoligosilane and alkoxychlorooligosilane monomers have the composition described by the general formula shown in (I):

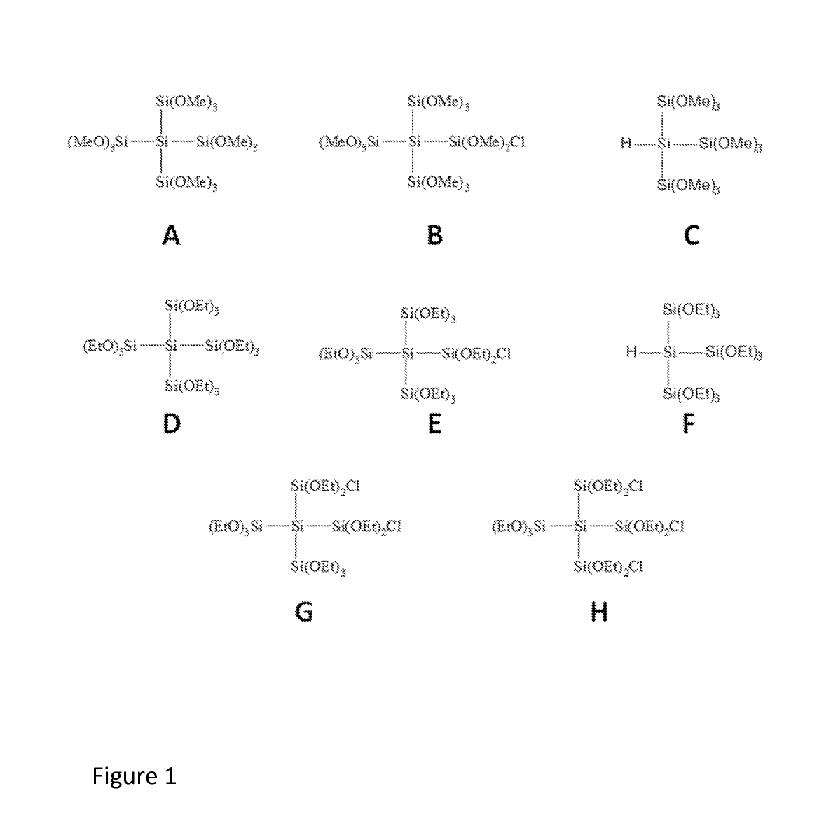

H_{w}Siₓ(OR)_{y}Cl_{z} (I)

where R is an alkyl group with a methyl (Me) or ethyl (Et) group being preferred; w is either 0 or 1; x is either 4 or 5; and y and z are numbers greater than or equal to zero defined by the relationship, (y+z)=(2x+2), when w=0 and x=5; or (y+z)=9 when w=1 and x=4. Referring now to FIG. 1, formulae A-H, examples of these monomers may include, but not be limited to, Si[Si(OMe)₃]₄ (1A), Si[Si(OMe)₃]₃[Si(OMe)₂Cl] (1B), HSi[Si(OMe)₃]₃ (1C), Si[Si(OEt)₃]₄ (1D), Si[Si(OEt)₃]₃[Si(OEt)₂Cl] (1E), HSi[Si(OEt)₃]₃ (1F), Si[Si(OEt)₃]₂[Si(OEt)₂Cl]₂ (1G), and Si[Si(OEt)₃][Si(OEt)₂Cl]₃ (1H), among others. As used herein, Me and Et refer to methyl and ethyl groups, respectively. The monomers may be prepared as the main products or occur as by-products resulting from the alkoxylation of perchloroneopentasilane, Si(SiCl₃)₄, with alcohols. The alkoxylation of Si(SiCl₃)₄ is performed in a manner that makes the desired monomers the dominant products of the reaction.

The monomers may be used to form inorganic polysilanesiloxane (PSSX) copolymers. The PSSX copolymers generally comprise SiₓO_{y}(OH)_{z} units, where y and z are numbers greater than or equal to zero defined by the relationship (2y+z) (2x+2) and x is either 4 or 5. In particular, x is 5 when desirable. The PSSX copolymers prepared according to the teachings of the present disclosure do not contain any Si—C covalent bonds. However, one skilled in the art will understand that the PSSX copolymers may contain a small amount of Si—C bonds resulting from an impurity or when desirable without exceeding the scope of the present disclosure.

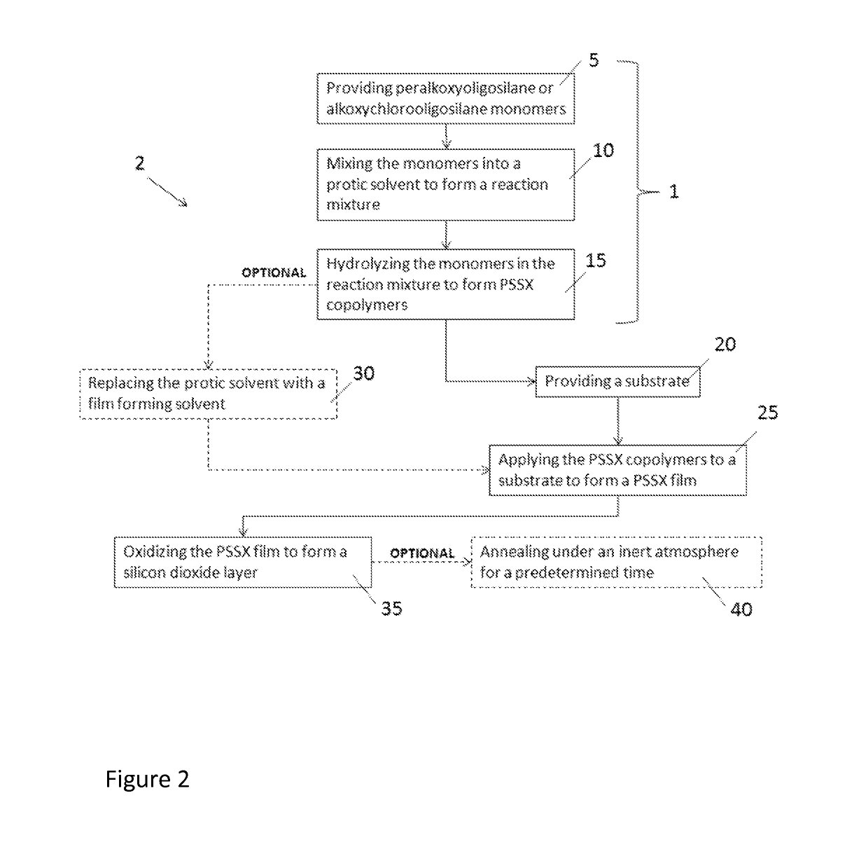

Referring now to FIG. 2, a method (1) of preparing PSSX copolymers according to one aspect of the present disclosure involves providing (5) peralkoxyoligosilane or alkoxychlorooligosilane monomers, mixing (10) the monomers into a protic solvent, such as an alcohol, to form a reaction mixture. The monomers in this reaction mixture are then hydrolyzed (15) under predetermined and controllable conditions to form PSSX copolymers. These monomers may be hydrolyzed in the protic solvent by the use of an excess amount of acidified water present in the solvent.

Still referring to FIG. 2, a method (2) for forming a dense silicon dioxide layer using the PSSX copolymers or resin as prepared in the protic hydrolysis solvent is shown. In this method (2), a substrate is first provided (20). This substrate preferably is an electronic device. However, one skilled in the art will understand that the PSSX copolymers made and used according to the teachings contained herein are described in conjunction with forming a dense dielectric or barrier layer within an electronic device in order to illustrate the system and method of use. The incorporation and use of such PSSX copolymers to form a silicon dioxide layer on other substrates is contemplated to be within the scope of the disclosure.

The PSSX copolymers may be applied (25) to the surface of a substrate to form a PSSX film. Alternatively, the protic solvent may be exchanged (30) for another common film forming solvent, such as propylene glycol monomethyl ether acetate (PGMEA), among others, prior to the PSSX copolymers being applied to the surface of the substrate. The monomer concentration, solvent, acidity, SiOMe:H₂O molar ratio, reaction time, solvent exchange procedure, and other reaction conditions may be optimized to make stable PSSX copolymers that exhibit superior thin film forming properties. The PSSX copolymers may be applied to the surface of a substrate using any conventional technique known to one skilled in the art, including but not limited to, spin coating, flow coating, and dip coating. For example, the inorganic PSSX resins may be deposited onto a silicon wafer substrate to form a defect-free film using standard spin coating methodology including a static spin rate of about 2000 rpm for about 20 seconds.

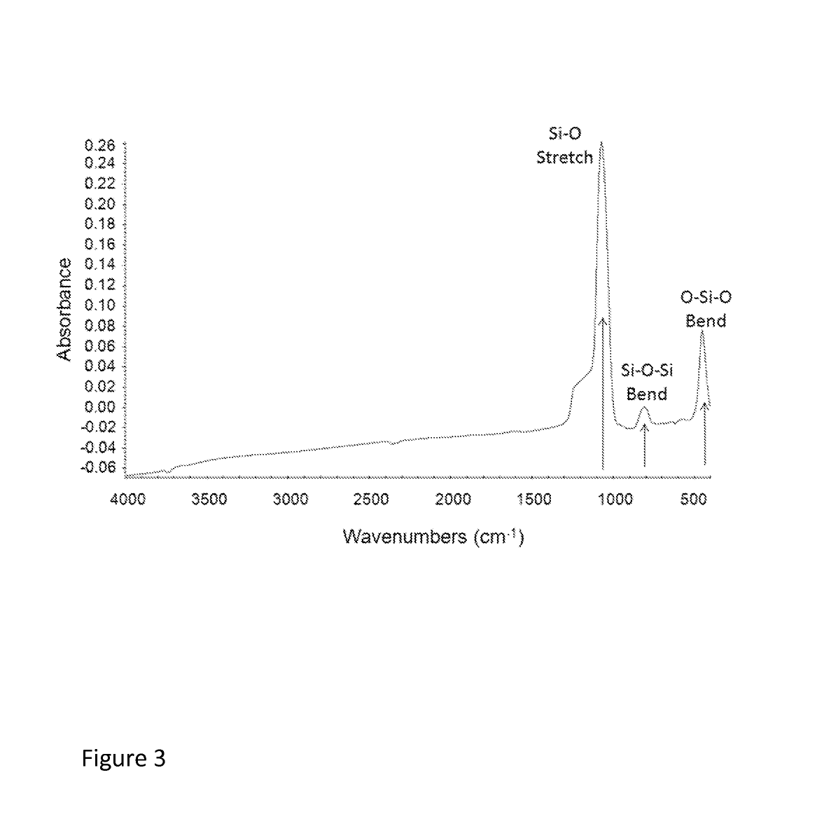

The PSSX films are finally oxidized (35) in order to convert the films to dense silicon dioxide layers. For example, the films may be mildly baked on a hotplate and cured in a furnace under mild oxidative conditions for a predetermined amount of time. Referring now to FIG. 3, the PSSX films can be converted to silicon dioxide at 400° C. or higher temperatures in the presence of steam or oxygen. The mildness of the oxidation conditions is demonstrated by the formation of relatively thin oxide layers on a silicon substrate, e.g., about 19 Å. The FTIR spectrum collected after a 550° C. steam cure exhibits strong infrared absorptions at about 1080, 800, and 460 cm⁻¹ associated with silicon dioxide. One skilled-in-the-art will understand that the strongest absorption at about 1080 cm⁻¹ is due to the stretching of the Si—O bond in silicon dioxide, while the weaker absorptions at about 800 and about 460 cm⁻¹ are caused by bending modes associated with the O—Si—O and Si—O—Si bonds in silicon dioxide, respectively.

Optionally, the density of the silicon dioxide layer may be further increased upon exposure to high temperature annealing (40) under an inert atmosphere, such as nitrogen or the like. Such further densification of the silicon dioxide makes the layer resistant to etching by hydrofluoric acid. For example, a PSSX film and a conventional hydrogen silsesquioxane (HSQ) film were applied to identical substrates and oxidized or cured under similar conditions at 550° C. in steam for 30 minutes and at 850° C. in nitrogen for 30 minutes. The silicon dioxide layer obtained from the PSSX film exhibited a 76 Å/min etch rate when exposed to a dilute 100:1 HF etchant. In comparison, this etch rate was observed to be much lower than the 125 Å/min etch rate measured for the silicon dioxide layer obtained from the HSQ film (control).

The following specific examples are given to illustrate the invention and should not be construed to limit the scope of the invention.

### EXAMPLE 1

### Preparation of Monomers

In this example, 261 grams of Si(SiCl₃)₄ dissolved in 1033 grams of toluene was mixed with 448 ml of methanol. All of the low boiling by-products were removed from the reaction mixture and a total of 209 grams of the methoxylated crude product was then isolated. The crude product was remixed into 1154 ml of methanol for a predetermined amount of time in order to purify the product. Upon removal of the methanol, a total of 206 g of high purity Si[Si(OMe)₃]₄ was collected. The resulting purity of the monomer, Si[Si(OMe)₃]₄, from this reaction was more than 90% with the overall yield being about 87%. The structure and purity of the product was verified using gas chromatography (GC), gas chromatography—mass spectrometry (GC-MS), nuclear magnetic resonance (NMR), Raman spectroscopy, and UV-Vis spectroscopy. One skilled in the art will understand that GC, GC-MS, NMR, Raman, and UV-Vis are conventional techniques used to verify composition and purity of materials prepared in a chemical reaction.

### EXAMPLE 2

### Preparation of PSSX Copolymers

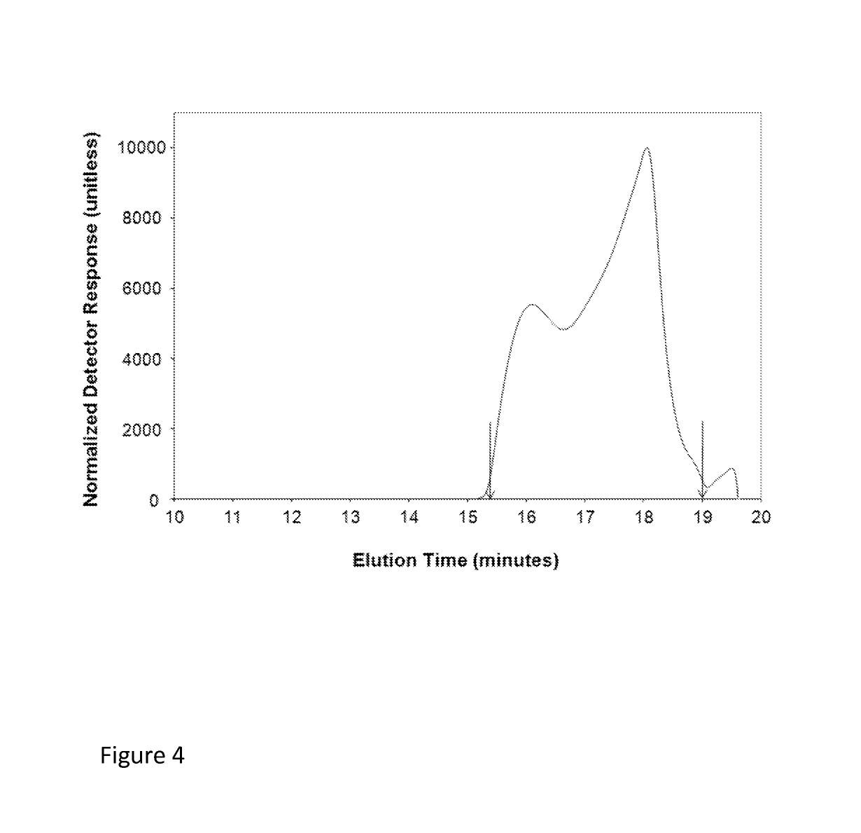

In this example, 16.66 grams of Si[Si(OMe)₃]₄ was hydrolyzed with 10.55 grams of 0.1 N HCl at a SiOMe:H₂O molar ratio of 1:1.5 in 70.37 grams of ethanol for 3 hours at room temperature to form the PSSX copolymers. Then 138.22 grams of PGMEA was added, and the solution was concentrated to 51.20 grams to yield a stable 15 wt. % resin solution. Referring now to FIG. 4, the PSSX copolymers in the PGMEA solvent were shown by gel permeation chromatography (GPC) to resolve in an elution time between about 15.5 and 19.0 minutes. One skilled in the art will understand that the measured GPC detector response can be transformed into a weight fraction, while the accurate calibration of the instrument allows elution times to be translated into a molecular weight scale. The PSSX copolymers prepared in this example exhibit an average number molecular weight (Mₙ) on the order of about 1500 amu and a weight average molecular weight (M_{w}) of about 3500 amu.

Although not wanting to be held to theory, it is believed that the SiSi₄ units remain intact in the copolymer or resin as determined by interpretation of measured ²⁹Si NMR data (not shown). In this example, the PSSX copolymers prepared according to the teachings of the present disclosure exhibit a composition of [Si₅Oₓ(OH)_{y}(OMe)_{z}]ₙ, where x, y, and z are numbers greater than or equal to zero and the sum of (2x+y+z) is equal to 12. Since the resin is rich in silanol concentration, it may optionally be stored in a freezer at, for example, −15° C., where it will remain stable for an extended period of time; i.e., exhibit a long shelf-life.

A person skilled in the art will recognize that the measurements described are standard measurements that can be obtained by a variety of different test methods. The test methods described in the examples represents only one available method to obtain each of the required measurements.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. Polysilanesiloxane (PSSX) copolymers for use in forming a silicon dioxide layer on a substrate, the PSSX copolymers comprising SiₓO_{y}(OH)_{z} units, wherein y and z are numbers greater than or equal to zero defined by the relationship (2y+z)≦(2x+2) and x is either 4 or 5.

2. The polysilanesiloxane copolymers of claim 1, wherein x is 5.

3. The polysilanesiloxane copolymers of claim 1, wherein the PSSX copolymers do not contain Si—C covalent bonds.

4. A method of preparing polysilanesiloxane (PSSX) copolymers, the method comprising the steps of:
providing a predetermined number of monomers selected from the group of peralkoxyoligosilanes, alkoxychlorooligosilanes, and mixtures thereof;
mixing the monomers into a protic solvent to form a reaction mixture; and
hydrolyzing the monomers in the reaction mixture to form PSSX copolymers.

5. The method of claim 4, wherein the step of providing a predetermined number of peralkoxyoligosilanes, or alkoxychlorooligosilanes monomers uses monomers having the general formula:
H_{w}Siₓ(OR)_{y}Cl_{z}
wherein R is an alkyl group; w is either 0 or 1; x is either 4 or 5; and y and z are numbers greater than or equal to zero; and (y+z)=(2x+2) when w=0 and x=5, or (y+z)=9 when w=1 and x=4.

6. The method of claim 5, wherein R is one selected from the group of a methyl group and an ethyl group.

7. The method of claim 4, wherein the monomers are selected as one from the group of Si[Si(OMe)₃]₄, Si[Si(OMe)₃]₃[Si(OMe)₂Cl], HSi[Si(OMe)₃]₃, and mixtures thereof.

8. The method of claim 4, wherein the step of hydrolyzing the monomers in the reaction mixture uses an excess of acidified water present in the protic solvent.

9. The method of claim 4, wherein the step of mixing the monomers into a protic solvent uses a protic solvent selected as one from the group of methyl alcohol, ethyl alcohol, and isopropyl alcohol.

10. The method of claim 4, wherein the method further comprises the step of replacing the protic solvent with a film forming solvent.

11. A method of preparing a silicon dioxide layer on a substrate, the method comprising the steps of:
preparing polysilanesiloxane (PSSX) copolymers according to claim 4;
providing a substrate;
applying the PSSX copolymers to the substrate to form a PSSX film; and
oxidizing the PSSX film to form a silicon dioxide layer.

12. The method according to claim 11, wherein oxidizing the PSSX film to form a silicon dioxide layer uses an oxidative process comprising the steps of:
exposing the PSSX film to one selected from the group of steam or oxygen gas; and
heating the PSSX film to less than about 600° C. for a predetermined amount of time.

13. The method according to claim 11, the method further comprises a step of annealing the silicon dioxide layer under an inert atmosphere for a predetermined amount of time.

14. The method of claim 11, wherein the step of applying the PSSX copolymers to a substrate uses a method selected as one from the group of spin coating, flow coating, and dip coating.

15. A silicon dioxide layer for use as a dielectric or barrier material in an electronic device, the silicon dioxide layer being prepared according to the method of claim 11.

16. An electronic device, the electronic device comprising a substrate and a silicon dioxide layer in contact with the substrate, the silicon dioxide layer being prepared according to the method of claim 11;
wherein the silicon dioxide layer exhibits a density sufficient for use as a dielectric or barrier material.
